(19) United States
(12) Patent Application Publication
(10) Pub. No.: US 2017/0111286 A1
(43) Pub. Date: Apr. 20, 2017

(54) STORAGE SYSTEM THAT INCLUDES A PLURALITY OF ROUTING CIRCUITS AND A PLURALITY OF NODE MODULES CONNECTED THERETO

(71) Applicant: KABUSHIKI KAISHA TOSHIBA, Tokyo (JP)

(72) Inventors: Kazunari KAWAMURA, Akishima Tokyo (JP); Atsuhiro KINOSHITA, Kamakura Kanagawa (JP); Takahiro KURITA, Sagamihara Kanagawa (JP)

(21) Appl. No.: 15/135,361

(22) Filed: Apr. 21, 2016

Related U.S. Application Data
(60) Provisional application No. 62/241,836, filed on Oct. 15, 2015.

(51) Int. Cl. H04L 12/863; H04L 12/761; H04L 29/06

(52) U.S. Cl. CPC H04L 47/50; H04L 69/22; H04L 45/16

(57) ABSTRACT

A storage system includes a storage unit having routing circuits networked with each other, each of the routing circuits configured to route packets to node modules that are connected thereto, each of the node modules including nonvolatile memory, and connection units, each coupled with one or more of the routing circuits for communication therewith, and configured to access each of the node modules through one or more of the routing circuits. When a first connection unit transmits to a target node module a lock command to lock a memory region of the target node module for access thereto, and then a second connection unit transmits a write command to the target node module before the first connection unit transmits to the target node module an unlock command to unlock the memory region, the target node module is configured to return an error notice to the second connection unit.

### CROSS-REFERENCE TO RELATED APPLICATIONS

This application is based upon and claims the benefit of priority from U.S. Provisional Patent Application No. 62/241,836, filed on Oct. 15, 2015, the entire contents of which are incorporated herein by reference.

### FIELD

Embodiments described herein relate generally to a storage system, in particular, a storage system that includes a plurality of routing circuits and a plurality of node modules connected thereto.

### BACKGROUND

A storage system of related art includes a plurality of non-volatile memories.

### BRIEF DESCRIPTION OF THE DRAWINGS

FIG. 1 illustrates an example of a storage system according to an embodiment.

FIG. 2 illustrates an example of a connection unit in the storage system.

FIG. 3 illustrates an example of a network of a plurality of FPGAs (field-programmable gate array) each of which includes a plurality of node modules.

FIG. 4 illustrates an example of the FPGA.

FIG. 5 illustrates an example of the node module.

FIG. 6 illustrates an example of a packet.

FIG. 7 illustrates transmission of a plurality of write requests to one node module in a transaction process.

FIG. 8 illustrates transmission of a plurality of write requests to a plurality of node modules in a transaction process.

FIG. 9 is a sequence diagram illustrating a flow of a process executed by the storage system according to a first embodiment.

FIG. 10 illustrates an example of information stored into a second NM memory of the node module.

FIG. 11 is a flowchart illustrating a flow of a first process executed by a node controller of the node module.

FIG. 12 is a flowchart illustrating a flow of a second process executed by a node controller 1 of the node module.

FIG. 13 illustrates an overview of a process executed in the storage system according to a second embodiment.

FIGS. 14 and 15 are a sequence diagram illustrating a flow of the process executed by the storage system according to the second embodiment.

FIG. 16 illustrates an example of data stored in a CU memory by a connection unit during a transaction process.

FIG. 17 is a flowchart illustrating a flow of a process executed by the node module according to the second embodiment.

FIG. 18 is a flowchart illustrating a flow of a process executed by a non-priority connection unit according to the second embodiment.

FIG. 19 is a flowchart illustrating a flow of a process executed by a priority connection unit according to the second embodiment.

FIG. 20 illustrates an overview of the process executed in the storage system according to a third embodiment.

FIGS. 21 and 22 are a sequence diagram illustrating the flow of the process executed by the storage system according to the third embodiment.

FIG. 23 is a flowchart illustrating the flow of the process executed by the node module according to the third embodiment.

FIG. 24 illustrates an example of hardware and software structure of a storage system according to an embodiment.

### DETAILED DESCRIPTION

A storage system according to an embodiment includes a storage unit having a plurality of routing circuits networked with each other, each of the routing circuits configured to route packets to a plurality of node modules that are connected thereto, each of the node modules including nonvolatile memory, and a plurality of connection units, each coupled with one or more of the routing circuits for communication therewith, and configured to access each of the node modules through one or more of the routing circuits. When a first connection unit transmits to a target node module a lock command to lock a memory region of the target node module for access thereto, and then a second connection unit transmits a write command to the target node module before the first connection unit transmits to the target node module an unlock command to unlock the memory region, the target node module is configured to return an error notice to the second connection unit.

Below, a storage system according to the embodiments is described with reference to the drawings.

### First Embodiment

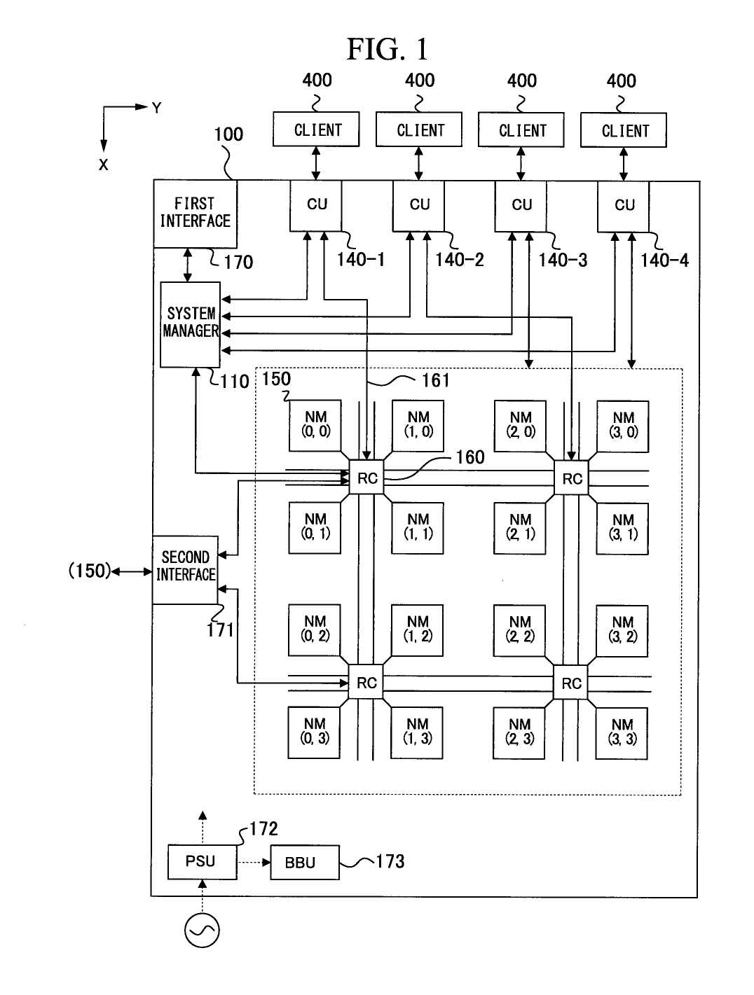

FIG. 1 illustrates an example of a storage system 100 according to an embodiment. In FIG. 1, the storage system 100 includes a system manager 110, connection units (CU) 140-1 to 140-4, one or more node modules (NM) 150, a first interface 170, a second interface 171, a power supply unit (PSU) 172, and a battery backup unit (BBU) 173. The configuration of the storage system 100 is not limited thereto. When no distinction is made among the connection units 140-1 to 140-4, a connection unit 140 is representatively used. Although the number of connection units 140 is set to four in FIG. 1, the storage system 100 may include an arbitrary number of connection units, whereas the number is at least two.

The system manager 110 manages the storage system 100. The system manager 110, for example, executes processes such as recording of a status of the connection unit 140, resetting, power supply management, failure management, temperature control, address management including management of an IP address of the connection unit 140.

The system manager 110 is connected to an administrative terminal (not shown), which is one of external devices, via the first interface 170. The administrative terminal is a terminal device which is used by an administrator which manages the storage system 100. The administrative terminal provides an interface such as a GUI (graphical user interface), etc., to the administrator, and transmits instructions to control the storage system 100 to the system manager 110.

Each of the connection units 140 is a connection element (a connection device, a command receiving device, a command receiving apparatus, a response element, a response device), which has a connector connectable with one or more clients 400. The client 400 may be an information processing device used by a user of the storage system 100, or it may also be a device which transmits various commands to the storage system 100 based on commands, etc., received from a different device. Moreover, the client 400 may be a device which, based on results of the information processing therein, generate various commands to transmit the generated commands to the storage system 100. The client 400 transmits, to a connection unit 140, a read command which instructs reading of data, a write command which instructs writing of data, a delete command which instructs deletion of data, etc., to the storage system 100. The connection unit 140, upon receiving these commands, uses a communications network between the below-described node modules to transmit a packet (described below) including information which indicates a process requested by the received command to the node module 150 having an address (logical address or physical address) corresponding to address designation information included in the command from the client 400. Moreover, the connection unit 140 acquires data stored in an address designated by the read command from the node module 150 and transmits the acquired result to the client 400.

The client 400 transmits a request, which designates a logical address, to the connection unit 140, and then the logical address in the request is converted to a physical address at an arbitrary location of the storage system 100 and the request including the converted physical address is delivered to a first NM memory 152 of the node module 150. There are no special constraints as to the location where the logical-to-physical address conversion is carried out, so that the address conversion may be carried out at an arbitrary location. Thus, in the description below, no distinction is made between the logical address and the physical address, and an “address” is used in general.

The node module 150 includes a non-volatile memory and stores data requested by the client 400. The node module 150 is a memory module (a memory unit, a memory including communications functions, a communications device with a memory, a memory communications device) and transmits data to a destination node module via a communications network which connects among a plurality of node modules 150.

Moreover, the storage system 100 includes a plurality of RCs 160 arranged in a matrix configuration. The matrix is a shape in which elements thereof are lined up in a first direction and a second direction which intersects the first direction.

A torus routing circuit is a circuit of the RCs configured when the node modules 150 are connected in a torus shape as described below. In this case, the RC 160 may be in a layer of the OSI (Open Systems Interconnection) reference model that is lower than the one configured when the torus-shaped connection form is not adopted for the node modules 150.

Each of the RC 160 transfers packets transmitted from the connection unit 140, the other RCs 160, etc., by a mesh-shaped network. The mesh-shaped network is a network which is configured in a mesh shape or a lattice shape, or, in other words, a network in which communications nodes are located at intersections of a plurality of vertical lines and a plurality of horizontal lines that form communications paths. Each of the individual RC 160 includes two or more RC interfaces 161. The RC 160 is electrically connected to the neighboring RC 160 via the RC interface 161.

The system manager 110 is electrically connected to each of the connection units 140 and the RCs 160.

Each of the node modules 150 is electrically connected to the neighboring node module 150 via the RC 160 and the below-described packet management unit (PMU) 180.

FIG. 1 shows an example of a rectangular network in which the node modules 150 are respectively arranged at lattice points. Here, coordinates of the lattice points are shown by coordinates (x, y) which are expressed in decimal notation. The position information of a node module 150 which is arranged at a lattice point is indicated with a relative node address (x_{D}, y_{D}) (in decimal notation) that corresponds to the coordinates of the lattice point. Moreover, in FIG. 1, a node module 150 which is located at the upper-left corner has a node address of the origin (0, 0). The relative node address of the other node modules 150 increases/decreases with varying of integer value in the horizontal direction (X direction) and the vertical direction (Y direction).

Each of the node modules 150 is connected to the other node modules 150 which neighbor in two or more different directions. For example, the upper-left node module 150 (0, 0) is connected to the node module 150 (1, 0), which neighbors in the X direction via the RC 160; the node module 150 (0, 1), which neighbors in the Y direction, which is a direction different from the X direction; and the node module 150 (1, 1), which neighbors in the slant direction.

Although each of the node modules 150 is arranged at a lattice point of the rectangular lattice in FIG. 1, the arrangement form of the node modules 150 is not limited to the one shown in FIG. 1. In other words, the shape of the lattice may be configured such that a node module 150 which is arranged at a lattice point may be connected to the node modules 150 which neighbor in two or more different directions, and may be a triangle, a hexagon, etc., for example. Moreover, while the node modules 150 are arranged in a two-dimensional plane in FIG. 1, they may be arranged in a three-dimensional space. When the node modules 150 are arranged in the three-dimensional space, a location of each node module 150 may be specified by three values of (x, y, z). Moreover, when the node modules 150 are arranged in the two-dimensional plane, those node modules 150 located on opposite sides may be connected together so as to form the torus shape.

The torus shape is a shape of connections in which the node modules 150 are circularly connected.

In FIG. 1, each of the connection units 140 is connected respectively to different one of the RCs 160. When each connection unit 140 accesses a node module 150, in the course of processing a request from the client 400, the connection unit 140 generates a packet which can be transferred by the RC 160, and executes and transmits the generated packet to the RC 160 connected thereto. One connection units 140 may be connected to a plurality of RCs 160, and one RC 160 may be connected to a plurality of connection units 140. For simplicity, the connections to the different RC 160 from the first two connection units 140 are shown in FIG. 1, but not from the other two connection units 140.

The first interface 170 electrically connects the system manager 110 and the administrative terminal.

The second interface 171 electrically connects RCs 160 located at an end of the storage system 100 and RCs of a different storage system. Such a connection causes the node modules included in the plurality of storage systems to be logically coupled, allowing use as one storage device.

In the storage system 100, a table for performing a logical/physical conversion may be held in each of the CUs 140, or in the system manager 110. Moreover, to perform the logical/physical conversion, arbitrary key information may be converted to a physical address, or a logical address, which is serial information, may be converted to the physical address. The second interface 171 is electrically connected to one or more RCs 160 via one or more RC interfaces 161. In FIG. 1, the two RC interfaces 161, each of which is connected to corresponding one of two RC 160s, are connected to the second interface 171.

The PSU 172 converts an external power source voltage provided from an external power source into a predetermined direct current (DC) voltage and provides the converted (DC) voltage to individual elements of the storage system 100. The external power source may be an alternating current power source such as 100 V, 200 V, etc., for example.

The BBU 173 has a secondary battery, and stores power supplied from the PSU 172. When the storage system 100 is electrically cut off from the external power source, the BBU 173 provides an auxiliary power source voltage to the individual elements of the storage system 100. The below-described node controller (NC) 151 of each node module 150 performs a backup to protect data with the auxiliary power source voltage.

(Connection Unit)

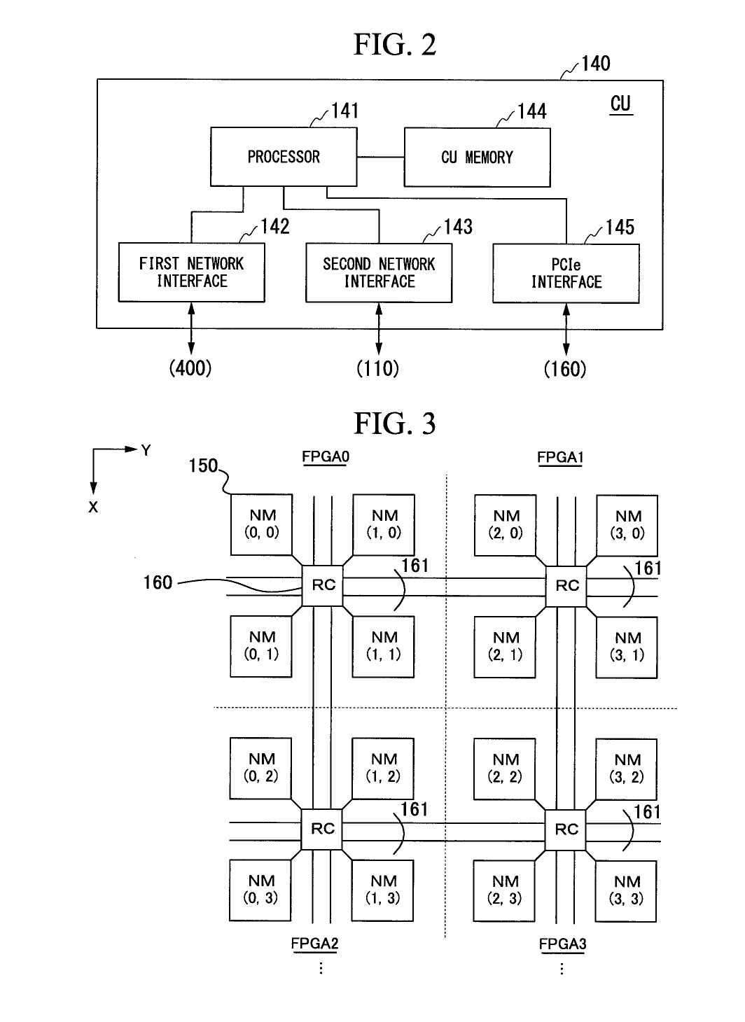

FIG. 2 illustrates one example of the connection unit 140. While the connection unit 140 may include a processor 141, such as a CPU; a first network interface 142; a second network interface 143; a connection unit memory 144; and a PCIe interface 145, the configuration of the connection unit 140 is not limited thereto. The processor 141 executes application programs using the connection unit memory 144 as a working memory to perform various processes. The first network interface 142 is an interface for connecting to the client 400. The second network interface 143 is an interface for connecting to the system manager 110. The connection unit memory 144 may be a RAM, for example, but may be another type of memory. The PCIe interface 145 is an interface for connecting to the RC 160.

(FPGA)

FIG. 3 illustrates an example of an array of FPGAs (field-programmable gate arrays) each of which includes a plurality of node modules 150. While the storage system 100 in FIG. 3 includes a plurality of FPGAs, each including one RC 160 and four node modules 150, the configuration of the storage system 100 may not be limited thereto. In FIG. 3, the storage system 100 includes four FPGAs 0-3. For example, the FPGA 0 includes one RC 160 and four node modules (0, 0), (1, 0), (0, 1), and (1, 1). Addresses of the four FPGAs 0-3 are respectively denoted by decimal notations as (000, 000), (010, 000), (000, 010), and (010, 010), for example.

The one RC 160 and the four node modules of each FPGA are electrically connected via the RC interface 161 and the below-described packet management unit 180. The RC 160 refers to FPGA address destinations x and y to perform routing in a data transfer operation.

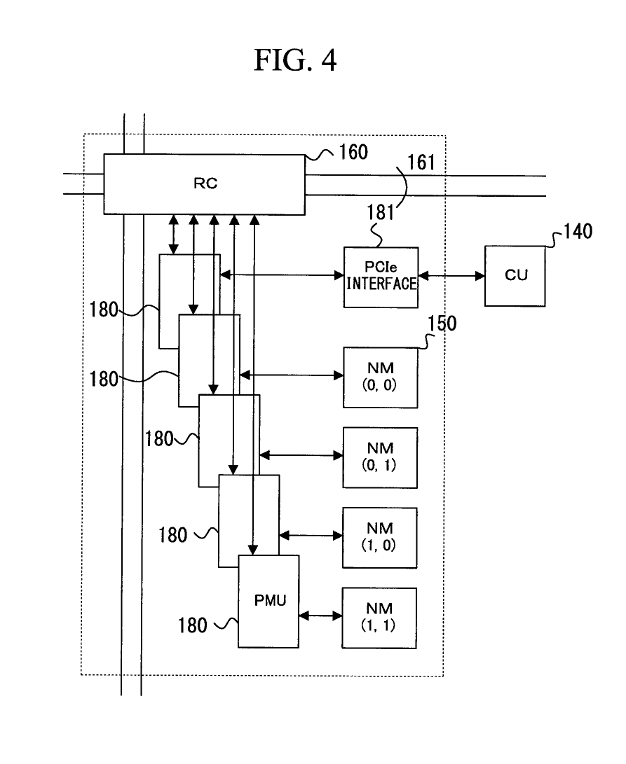

FIG. 4 illustrates an example of the FPGA. Each of the FPGAs 0-3 has a configuration shown in FIG. While the FPGA in FIG. 4 includes one RC 160, four node modules 150, five packet management units 180, and a PCIe interface 181, the configuration of the FPGA is not limited thereto.

Four packet management units 180 are provided in correspondence with four node modules 150, and one package management unit 180 is provided in correspondence with the PCIe interface 181. Each of the packet management units 180 analyzes a packet transmitted by the connection unit 140 and the RC 160. The packet management unit 180 determines whether coordinates (relative node address) included in the packet and its own coordinate (relative node address) match. If the coordinate in the packet and the own coordinate match, the packet management unit 180 transmits the packet directly to the node module 150 which corresponds thereto. On the other hand, if the coordinate in the packet and the own coordinate do not match (when they are different coordinates), the packet management unit 180 returns information that they do not match, to the RC 160.

For example, when the node address of the final destination position is (3, 3), the packet management unit 180 connected to the node address (3, 3) determines that the coordinate (3, 3) in the analyzed packet and the own coordinate (3, 3) match. Therefore, the packet management unit 180 connected to the node address (3, 3) transmits the analyzed packets to the node module 150 of the node address (3, 3). The transmitted packets are analyzed by a node controller 151 (below described) of the node module 150. In this way, the FPGA cause a process corresponding to a request described in a packet to be performed, such as writing data into the non-volatile memory within the node module 150.

The PCIe interface 181 transmits a request or a packet, etc., from the connection unit 140 to the corresponding packet management unit 180. The packet management unit 180 analyzes the request, the packet, etc. The packet transmitted to the packet management unit 180 corresponds to the PCIe interface 181 are transferred to the different node module 150 via the RC 160.

(Node Module)

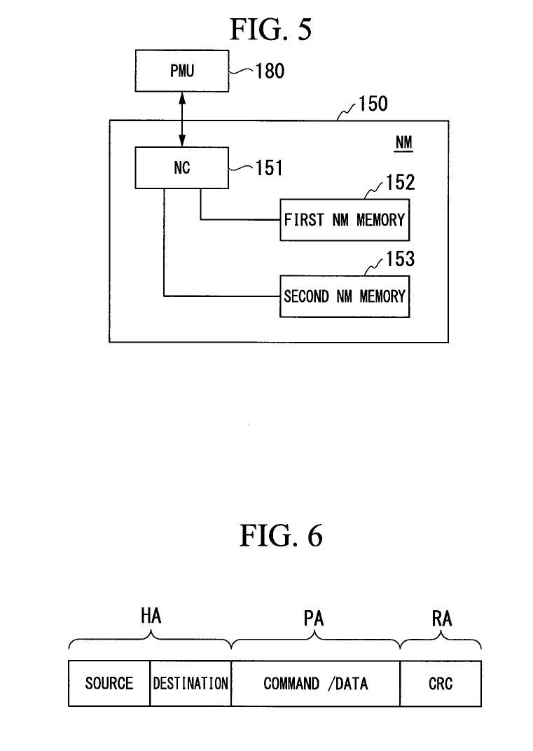

The node module 150 according to the present embodiment is described below. FIG. 5 illustrates one example of the node module.

The node module 150 may include the node controller 151, a first node module (NM) memory 152, which functions as a storage memory, and a second NM memory 153, which the node controller 151 uses as a work area. The configuration of the node module 150 is not limited thereto.

The packet management unit 180 is electrically connected to the node controller 151. The node controller 151 receives a packet via the packet management unit 180 from the connection unit 140 or the other node modules 150, or transmits a packet via the packet management unit 180 to the connection unit 140 or the other node modules 150. When the destination of the packet is the own node module 150, the node controller 151 executes a process in accordance with the packet (a request in the packet). For example, when the request is an access request (a read request or a write request), the node controller 151 executes an access to the first node module memory 152. When the destination of the received packet is not the node module 150 corresponding to an own RC 160, the RC 160 transfers the packet to the other RC 160.

The first node module memory 152 may be a non-volatile memory such as a NAND flash memory, a bit cost scalable memory (BiCS), a magnetoresistive memory (MRAM), a phase change memory (PcRAM), a resistance change memory (RRAM®)), etc., or a combination thereof, for example.

The second NM memory 153 may be various RAMs such as a DRAM (dynamic random access memory). When the first node module memory 152 provides a function as a working area, the second NM memory 153 does not have to be disposed in the node module 150. In general, the first NM memory 152 is non-volatile memory and the second NM memory 153 is volatile memory. Further, in one embodiment, the read/write performance of the second NM memory 153 is better than that of the first NM memory 152.

In this way, the RC 160s are connected by the RC interfaces 161, and each of the RCs 160 and each of the corresponding node modules 150 is connected via the PMU 180, forming a communications network of the node modules 150. The configuration of the connection is not limited thereto. For example, the NM 150s may be directly connected, not via the RC 160, to form the communication network.

(Interface Standards)

Interface standards in the storage system 100 according to the present embodiment are described below. According to the present embodiment, the following standards can be employed for an interface which electrically connects the above-described elements.

For the RC interface 161 which connects between adjacent RCs 160, LVDS (low voltage differential signaling) standards, etc., are employed.

For the RC interface 161 which electrically connects one of the RCs 160 and the connection unit 140, the PCIe (PCI Express) standards, etc., are employed.

For the RC interface 161 which electrically connects one of the RCs 160 and the second interface 171, the above-described LVDS standards, JTAG (joint test action group) standards, etc., are employed.

For the RC interface 161 which electrically connects one of the node modules 150 and the system manager 110, the above-described PCIe standards and the I2C (Inter-integrated Circuit) standards are employed.

These interface standards are one example, so that other interface standards can be employed as required.

(Packet Configuration)

FIG. 6 illustrates one example of a packet. The packet to be transmitted in the storage system 100 according to the present embodiment includes a header area HA, a payload area PA, and a redundancy area RA.

The header area HA includes, for example, addresses (from_x, from_y) in the X and Y directions of the transmission source, addresses (to_x, to_y) in the X and Y directions of the transmission destination, etc.

The payload area PA includes a request, data, etc., for example. The data size of the payload area PA is variable.

The redundancy area RA includes CRC (cyclic redundancy check) codes, for example. The CRC codes are codes (information) used for detecting errors in data in the payload area PA.

The RC 160, upon receiving the packet of the above-described configuration, determines a routing destination based on a predetermined transfer algorithm. Based on the transfer algorithm, the packet is transferred between the RC 160s to reach the node module 150 of a final destination that has the node address.

For example, based on the above-described transfer algorithm, the RC 160 determines a node module 150 that is located on a path along which the number of transfer times of the packet from the own node module 150 to a destination node module 150 is the minimum, as a transfer-destination node module 150. Moreover, when there are a plurality of paths along which the number of transfer times of the packet from the own node module 150 to the destination node module 150 is the minimum, one of the plurality of paths is selected by an arbitrary method. Similarly, when a node module 150 which is located on the path has a defect or is busy, the RC 160 determines a different node module 150 as a transfer destination.

As a plurality of node modules 150 is logically connected in a mesh network, there may be a plurality of paths along which the number of transfer times of a packet is the minimum as described above. In such a case, even when a plurality of packets directed to a specific node module 150 as a destination is output, each of the output packets is transferred by the above-described transfer algorithm through different one of paths. As a result, concentration of access to an intermediate node module 150 may be avoided and the throughput of the whole storage system 100 may not be compromised.

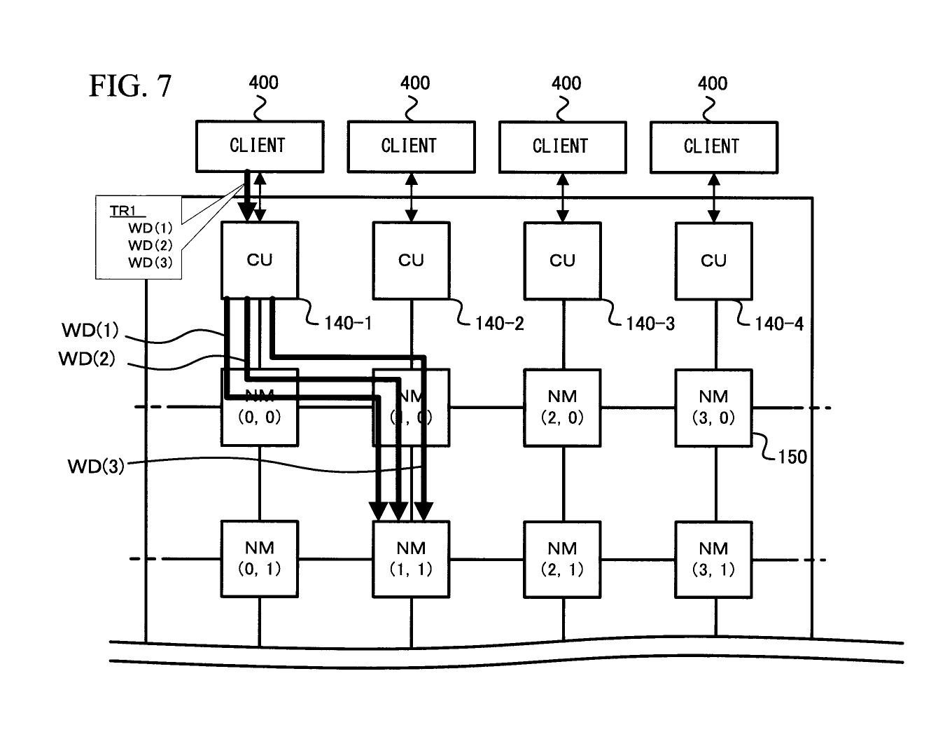

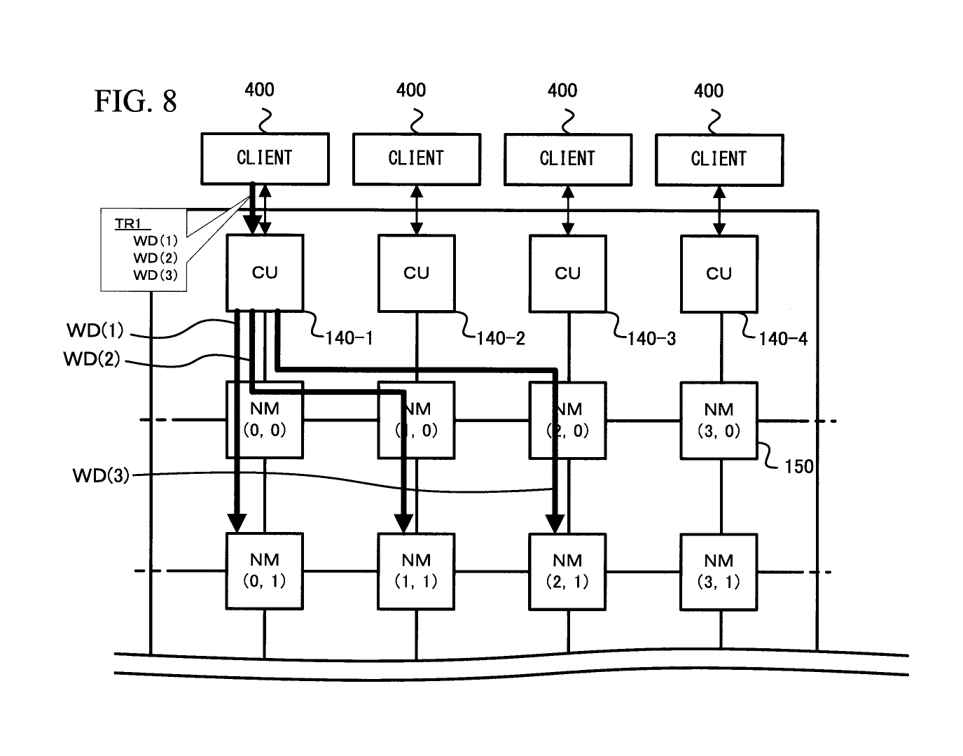

Below, an operation of each element of the storage system 100 is described. The connection unit 140 according to the present embodiment may receive, as a series of processes, a plurality of write commands from the client 400 and transmit a plurality of write requests to the node modules 150 based on the write commands. Below, this series of processes is called a transaction process. The “series of processes” refers to a collection of processes. Moreover, “receiving as the series of processes” may refer to collectively receiving a group of the plurality of write commands, or may refer to receiving a plurality of write commands and information indicating that the plurality of write commands is for the series of processes (for example, identification information for the transaction process). Moreover, “receiving as the series of processes” may refer to first receiving a command which requests the transaction process, which includes identification information of a plurality of commands to be transmitted subsequently, and receiving the plurality of commands identified by the identification information. FIGS. 7 and 8 illustrate a transaction process.

Moreover, “accepting” an access request such as a write request, etc., in the description below refers to the node module 150 executing a process specified by an access request from the connection unit 140 and returning information indicating a completion of execution of the process to the connection unit 140.

FIG. 7 illustrates how a write request is transmitted to a destination node module 150 in one transaction process. The node modules 150 are schematically shown as being connected directly, omitting the description for the RCs 160. The illustrated transaction process TR1 is a process of writing three units of write data WD (1), WD (2), and WD (3). A request for this transaction process TR1 includes an address within a node module (1, 1), for example. In this case, a connection unit 140-1 which accepted a request for the transaction process TR1 writes all of the three units of write data WD (1), WD (2), and WD (3) into the node module (1, 1). In order to write the write data, the three units of write data WD (1), WD (2), and WD (3) are respectively included in three write requests, and transmitted to the node module (1, 1) as a destination.

FIG. 8 illustrates a manner of transmitting write requests to a plurality of (destination) node modules 150 in one transaction process. The illustrated transaction process TR1 is a process of writing three units of write data WD (1), WD (2), and WD (3). A request for this transaction process TR1 includes three addresses within the node modules (0, 1), (1, 1), and (2, 1), for example. In this case, a connection unit 140-1, which accepted the request for the transaction process TR1, writes respectively three units of write data WD (1), WD (2), and WD (3) into the node modules (0, 1), (1, 1), and (2, 1). IN order to write the write data, the three units of write data WD (1), WD (2), and WD (3) are respectively included in three write requests and transmitted to the node modules (0, 1), (1, 1), and (2, 1) as destinations.

(Lock Control)

When a write request is transmitted to a destination node module 150, the connection unit 140 also transmits a lock request to the destination node module 150. The lock request is a request that write requests to the same address from the other connection units 140 be not executed. The lock request is generated in accordance with a predetermined rule, and the target address of the lock request is recognizable by a node module 150 that receives the lock request. Moreover, the lock request may include identification information of the transmission-source connection unit 140 that issued the lock request. While the lock request may include flag information that indicated the request is a lock request and information indicating the address to be locked, the contents of the lock request is not limited thereto. The lock request may be transmitted in the above-described packet format, or in a different format.

Based on the lock request received from the connection unit 140, the destination node module 150 determines a priority connection unit (a first connection unit) from which the node module 150 accepts a write request on the target address in priority to the other connection units 140. For example, when the node module 150 has not yet approved any lock request for an address therein from any connection unit 140 at the time a lock request is received, the node module 150, determines the request-source connection unit 140 that sent the lock request as the priority connection unit. “Approving” is bringing into a status in which only a write process requested by a connection unit 140 that issued the lock request. The node module 150 transmits information indicating that the lock request was approved, to the connection unit that issued the lock request. “Information indicating that lock request was approved” is generated by a predetermined rule, and identification information of the lock request is recognizable by the node module 150 that receives the lock request. Moreover, identification information of the connection unit 140 that issued the lock request may be added to the information indicating that the lock request was approved. Also, the information indicating that the lock request was approved may include flag information indicating the approval of the lock request and identification information of the lock request. The contents of the information are not limited thereto. The information indicating that the lock request was approved may be transmitted in a format of a packet, or may be transmitted in a different format. Through the lock request, the target address of the node module 150 turns into a locked status (being locked).

The use of the lock request makes it possible for a node module 150 to exclusively execute requests from the priority connection unit 140 from which lock request is approved, in the storage system 100.

That is, according to the first embodiment, the node module 150 does not execute writing (a write process) of data in the lock target address based on write requests from non-priority connection units other than the priority connection unit until the lock state is released by the priority connection unit. “Does not execute” may include a case in which a write process based on a received write request is merely not executed and a case in which the write process based on the received write request is not executed and information indicating that the write process will not be executed is transmitted to a non-priority connection unit 140 that issued the write request.

In this way, the storage system 100 may prevent an occurrence of data inconsistency by accepting write requests from multiple connection units 140.

Moreover, according to the first embodiment, when a read request to read data from a lock target address is received from a non-priority connection unit after the lock target address has been locked and before a write process based on a write request from a priority connection unit is executed, the node module 150 executes a read process to read data from the lock target address (locked address) and transmits the read data to the non-priority connection unit that issued the read request.

In this way, the storage system 100 may perform a read process with respect to the locked address and maintain the responsiveness as a storage system to a high level.

On the other hand, according to the first embodiment, if a read request to read data from a locked address is received from a non-priority connection unit after a write process based on a write request from a priority connection unit has been started and before the locked state is released, the node module 150 does not execute the read process based on the read request from the non-priority connection unit.

That is, in the storage system 100, data are not provided to the client 400 in a status in which only part of write requests have been implemented, when a plurality of write requests are transmitted during a series of processes.

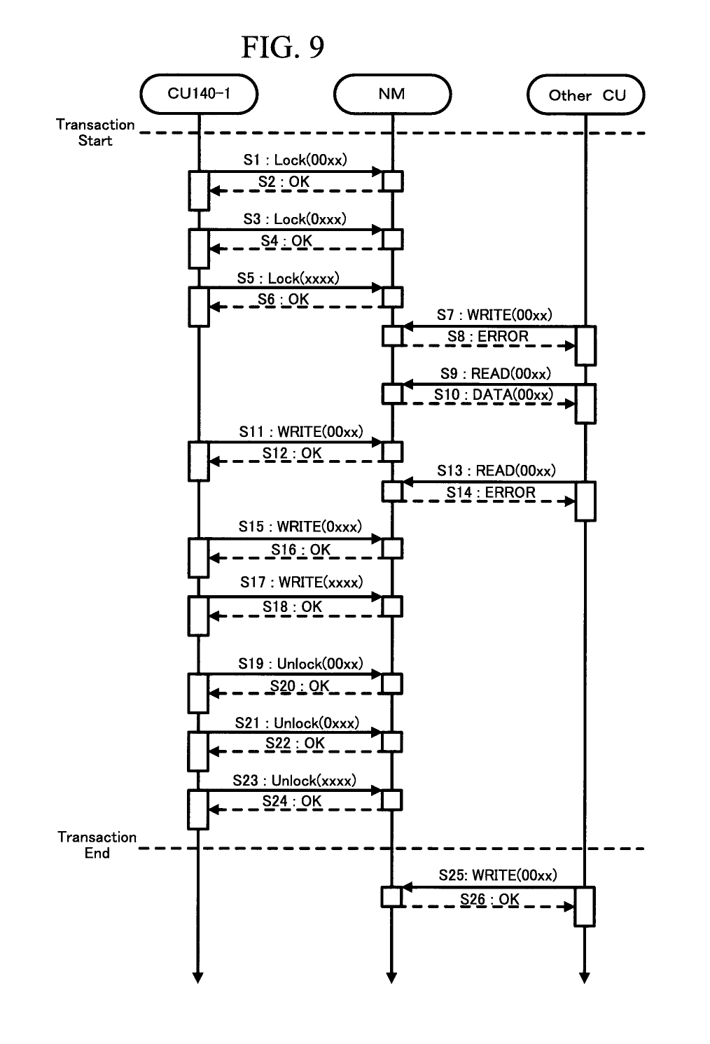

FIG. 9 is a sequence diagram illustrating a flow of a process executed by the storage system 100 according to the first embodiment. Here, it is assumed that the transaction process is initiated by the connection unit 140-1. Moreover, a target node module 150 into which data are written through the transaction process is assumed to be one node module 150.

First, the connection unit 140-1 transmits a lock request designating an address (00xx) to the node module 150 (S1). In response thereto, the node module 150 returns information (OK in FIG. 9) indicating that an approval has been made if no lock request for the same address from the other connection units 140 has been approved (S2). In this way, the connection unit 140-1 becomes “a priority connection unit” with respect to the address (00xx).

Next, the connection unit 140-1 transmits a lock request designating an address (0xxx) to the node module 150 (S3), and the node module 150 returns information (OK) indicating that an approval was made (S4). Next, the connection unit 140-1 transmits a lock request designates an address (xxxx) to the node module 150 (S5), and the node module 150 returns information (OK) indicating that an approval was made (S6).

Thereafter, when a write request designating the address (00xx) is transmitted to the node module 150 from one of the other connection units 140 (“a non-priority connection unit”), the node module 150 returns information indicating an error to the non-priority connection unit 140 (S8). While the non-priority connection unit 140 may transmit a lock request to the node module 150 before the process in S7 (i.e., transmitting the write request), the description on this lock request is omitted in FIG. 9.

On the other hand, when a read request designating the address (00xx) is transmitted to the node module 150 from a non-priority connection unit 140 (S9), the node module 150 reads data from the designated address and returns the read data to the non-priority connection unit 140 (S10).

Next, the connection unit 140-1 transmits a write request designating the address (00xx) to the node module 150 (S11). The node module 150 writes data included in the write request into the designated address and returns information (OK) indicating that a write process based on the write request has been completed (OK) to the connection unit 140-1 (S12).

Thereafter, when a read request designating the address (00xx) is transmitted to the node module 150 from a non-priority connection unit 140 (S13), the node module 150 returns information indicating an error to the non-priority connection unit 140 (S14).

Next, the connection unit 140-1 transmits a write request designating the address (0xxx) to the node module 150 (S15). The node module 150 writes data included in the write request into the designated address and returns information (OK) indicating that a write process based on the write request has been completed to the connection unit 140-1 (S16). Next, the connection unit 140-1 transmits a write request designating the address (xxxx) to the node module 150 (S17). The node module 150 writes data included in the write request into the designated address and returns information (OK in FIG. 9) indicating that a write process based on the write request has been completed to the connection unit 140-1 (S18).

Upon receiving information indicating completion for all write requests from the node module 150, the connection unit 140-1 operates to release the locked state of the target addresses. In order to release the locked state, the connection unit 140-1 transmits, to the node module 150, an unlock request (Unlock in FIG. 9) to release the locked state of the address (00xx), and the node module 150 returns information (OK) indicating that the release was approved to the connection unit 140-1 (S20). Next, the connection unit 140-1 transmits an unlock request (Unlock) for the address (0xxx) to the node module 150 (S21), and the node module 150 returns information (OK) indicating that the release was approved to the connection unit 140-1 (S22). Next, the connection unit 140-1 transmits an unlock request (Unlock) for the address (xxxx) to the node module 150 (S23), and the node module 150 returns information (OK) indicating that the release was approved, to the connection unit 140-1 (S24). In this way, releasing of the locked state is achieved by transmitting the unlock request to the node module 150 from the connection unit 140-1 which has transmitted the lock request and receiving information indicating that the unlock request was approved from the node module 150. The unlock request is a request to release the locked state of an address, in which no data from the non-priority connection units 140 are written. The unlock request is generated by a predetermined rule, and the address targeted for unlock is recognizable by the node module 150 that receives the unlock request. Moreover, the unlock request may include identification information of the connection unit 140 that issued the unlock request. Further, the unlock request may include flag information indicating that the request is for unlock (that can be distinguished from flag information included in the lock request) and information indicating the unlock target. The contents of the unlock request is not limited thereto. The unlock request may be transmitted in the packet format or a different format.

When a write request designating the address (00xx) is transmitted from a non-priority connection unit 140 to the node module 150, after the locked state of the address is released (S25), the node module 150 performs a process of writing data into the designated address in response to the write request and returns information (OK) indicating that the write process based on the write request has been completed to the non-priority connection unit 140 (S26). A lock request may be transmitted to the node module 150 from the non-priority connection unit 140 before S25 and S26, and the node module 150 may perform a process of approving the lock request.

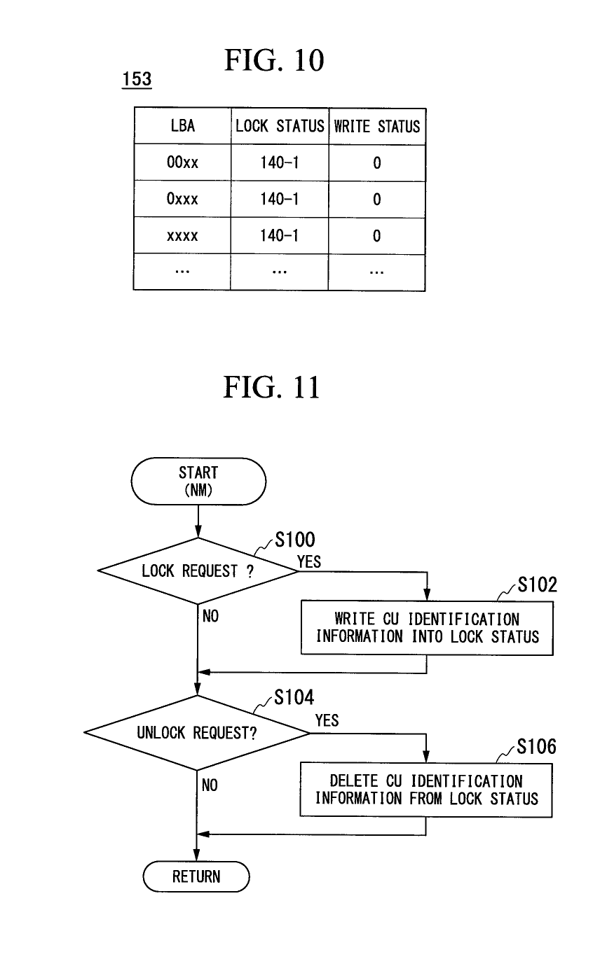

FIG. 10 illustrates an example of information stored into the second NM memory 153 of the node module 150. The node controller 151 of the node module 150 may cause the second NM memory 153 to store, for each key information or each LBA (logical block address) corresponding to the first node module memory 152, information (lock status) specifying the priority connection unit 140 which has acquired the approval of the lock request and information (write status) indicating whether a write process corresponding to the lock request has been completed. The LBA is a logical address which is assigned a serial number from 0 for each set of predetermined bytes. Moreover, the lock status and the write status may be indicated on the basis of physical address in the second NM memory 153 instead of the LBA or key information.

For example, upon approving the lock request from the connection unit 140-1, the node controller 151 writes identification information of the connection unit 140-1 to the lock status field. Moreover, the node controller 151 writes zero into the write status field when the LBA is not locked or when the LBA is locked but the write process corresponding to the lock request has not been completed, and writes one into the write status field when the write process corresponding to the lock requirement has been completed. The node controller 151 refers to such internal statuses shown in FIG. 10 to execute the process shown in FIG. 9.

FIG. 11 is a flowchart illustrating a flow of a first process executed by the node controller 151 of the node module 150. The process of the present flowchart is executed for each address of the node module 150 for which the priority node module accesses. First, the node controller 151 determines whether a lock request has been received (S100). If the lock request has been received (Yes in S100), the node controller 151 writes identification information of the connection unit 140 that transmitted the lock request, into the second NM memory 153 (S102).

Next, the node controller 151 determines whether the unlock request has been received (S104). If the unlock request has been received (Yes in S104), the node controller 151 deletes identification information of the connection unit 140 that transmitted the unlock request, from the second NM memory 153 (S106).

In this way, the node module 150 writes information on the priority connection unit into the second NM memory 153 and updates information on the priority connection unit upon completion of the write process based on the write request from the priority connection unit. Alternatively, the node module 150 may write information on the priority connection unit into the first NM memory 152 instead of the second NM memory 153.

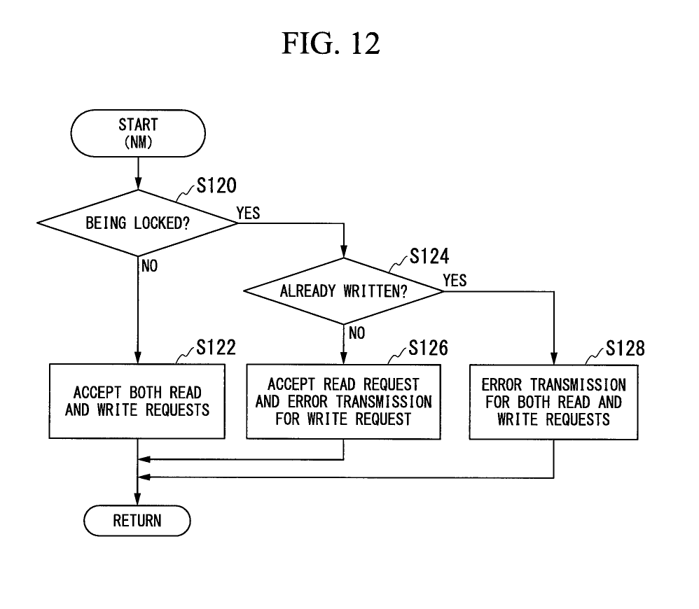

FIG. 12 is a flowchart illustrating a flow of a second process executed by the node controller 151 of the node module 150. The process of the present flowchart is executed when an access request (a write request or a read request) is received, in parallel with the process of the flowchart in FIG. 11.

First, the node controller 151 refers to the lock status field of the second NM memory 153 and determines whether an address designated by the access request is locked (S120). If the address is not locked (No in S120), the node controller 151 accepts both the read request and the write request (S122).

When the address is locked (Yes in S120), the node controller 151 refers to the write status field of the second NM memory 153 and determines whether a process of writing data into the LBA has been completed (writing has already been made at the LBA) (S124). If the writing has not been completed yet (No in S124), the node controller 151 accepts a read request, but transmits an error to a write request (S126).

When the address is being locked and also the writing into the address has already been completed (Yes in S124), the node controller 151 transmits an error to both a read request and a write request (S128).

The first embodiment as described above makes it possible to appropriately execute exclusive control in accordance with a system configuration.

### Second Embodiment

Below, a second embodiment is described. In the description below, the same numerals are used for elements of the storage system 100 that are same as those described in the first embodiment, and repeated description of those elements will be omitted.

In the second embodiment, when an access request with respect to a locked address is received from a non-priority connection unit, which is different from a priority connection unit, the node module 150 transmits information on the priority connection unit to the non-priority connection unit. The non-priority connection unit, which received the information on the priority connection unit, transmits an access request to the priority connection unit. Then, the priority connection unit, which received the access request from the non-priority connection unit, executes a process based on the access request.

In this way, the connection unit 140 and the node module 150 may cooperate in the storage system 100 to appropriately execute exclusive control in accordance with the system configuration.

For example, according to the second embodiment, when the access request received from the non-priority connection unit is a write request, the priority connection unit, as a proxy for the non-priority connection unit, conducts a proxy transmission of the write request received from the non-priority connection unit, to the node module 150 including the target address of the write request. This proxy transmission may be conducted after a write process based on a request accepted from the client 400 by the priority connection unit has been completed.

In this way, the storage system 100 may prevent data inconsistency caused when the priority connection unit accepts write requests on an unlimited basis. Moreover, the non-priority connection unit does not repeatedly retransmit the write request to the node module including the locked address, and as a result, communication traffic within the system can be reduced.

Moreover, according to the second embodiment, when the priority connection unit transmits a plurality of write requests received from the client to the node module 150 during a series of processes (transaction processes), the priority connection unit, in advance, reads data (reads regardless of read requests) from the target addresses of the write requests. I If the priority connection unit receives a read request from a non-priority connection unit after receiving information indicating an approval of a lock request and before the priority connection unit recognizes that the write process based on the plurality of write requests has been completed, the priority connection unit transmits the data read in advance to the non-priority connection unit. Recognizing the completion of the write process based on the plurality of write requests refers to a state in which the priority connection unit transitions to a status after the write process based on the plurality of write requests has been completed. The priority connection unit recognizes the completion of the write process based on the plurality of write requests when at least the information indicating the completion of the write process for the plurality of write requests is received from the node module 150. Below, recognizing the completion of the write process based on the plurality of write requests is called “Committing”. If a response to the plurality of write requests is received from the node module 150, the priority connection unit may immediately conduct the “committing,” or may conduct the “committing” when some other conditions are met.

In this way, the storage system 100 may prevent a completion notice from being provided to the client 400 in a state in which only a write process based on the write requests has been partially performed.

According to an alternative embodiment of the second embodiment, when the priority connection unit transmits a plurality of write requests received from the client to the node module 150 during a series of processes (transaction processes), the priority connection unit may not read data in advance from the target address of the write requests. Instead, the priority connection unit may read data from the target address of the write requests in response to a read request from the non-priority connection unit after receiving information indicating an approval of the lock request and before recognizing the completion of the write process based on the plurality of write requests, and transmit the read results to the non-priority connection unit.

Moreover, according to the second embodiment, if the priority connection unit receives a read request from a non-priority connection unit after the “committing” and before releasing of the locked state, the priority connection unit transmits data corresponding to the completed write request to the non-priority connection unit. Here, data to be transmitted to the non-priority connection unit may be data which are temporarily stored in the CU memory 144, or may be data which are read from the node module 150 to transmit to the non-priority connection unit.

In this way, upon completion of the write process based on the whole write requests during the transaction process, the storage system 100 may rapidly provide new data to the client 400 without waiting for the process to unlock the address. Moreover, in comparison to the first embodiment, a read request may be accepted for a longer period of time and the responsiveness of the storage system may be further increased.

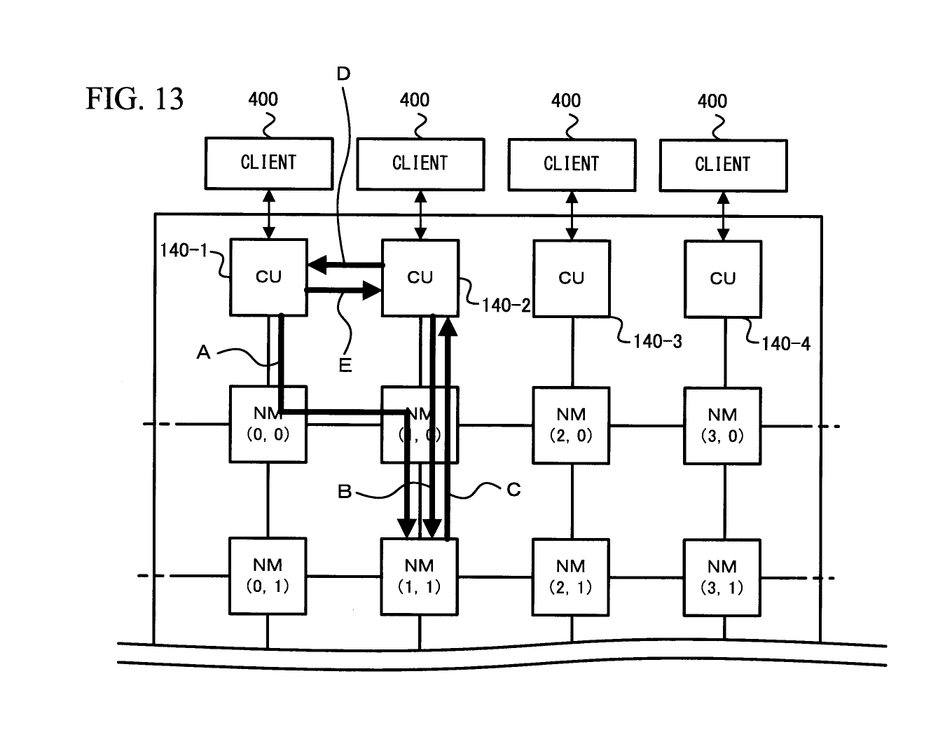

FIG. 13 illustrates an overview of a process executed in the storage system 100 according to the second embodiment. First, a connection unit 140-1 transmits, to a node module 150 (1, 1) (arrow A), a lock request, and the node module 150 (1, 1) accepts the lock requests. Next, when a connection 140-2 transmits an access request to the node module 150 (1, 1) (arrow B), the node module 150 (1, 1) returns, to the connection unit 140-2, information indicating that the node module is locked by the connection unit 140-1 (arrow C). The information returned includes identification information of the connection unit 140-1.

The connection unit 140-2 sends the access request to the connection unit 140-1, which is a priority connection unit (arrow D). The connection unit 140-1 performs a process based on the access request and transmits a response to the connection request 140-2 (arrow E).

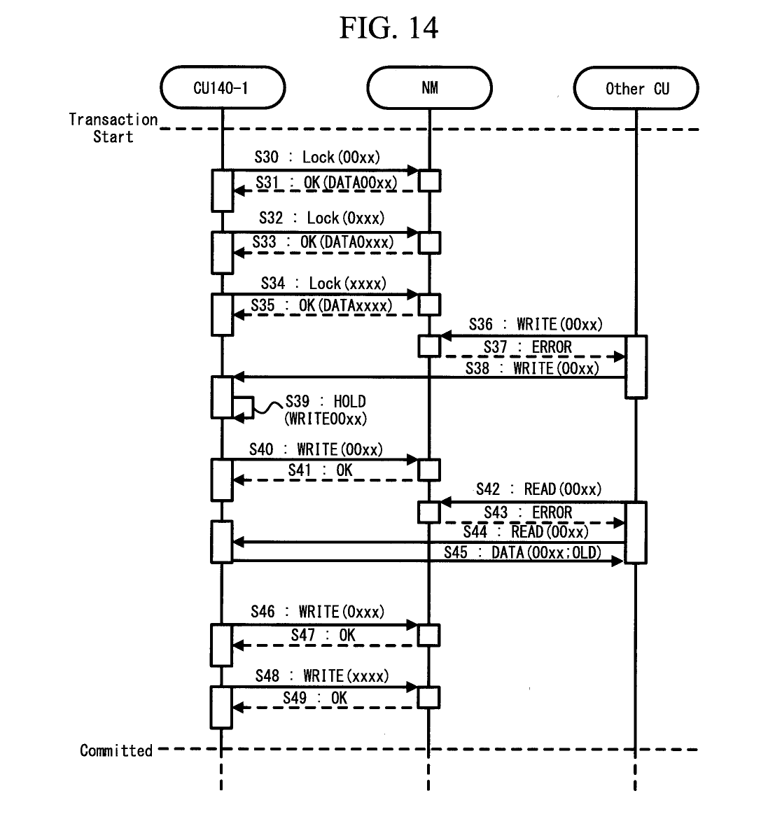

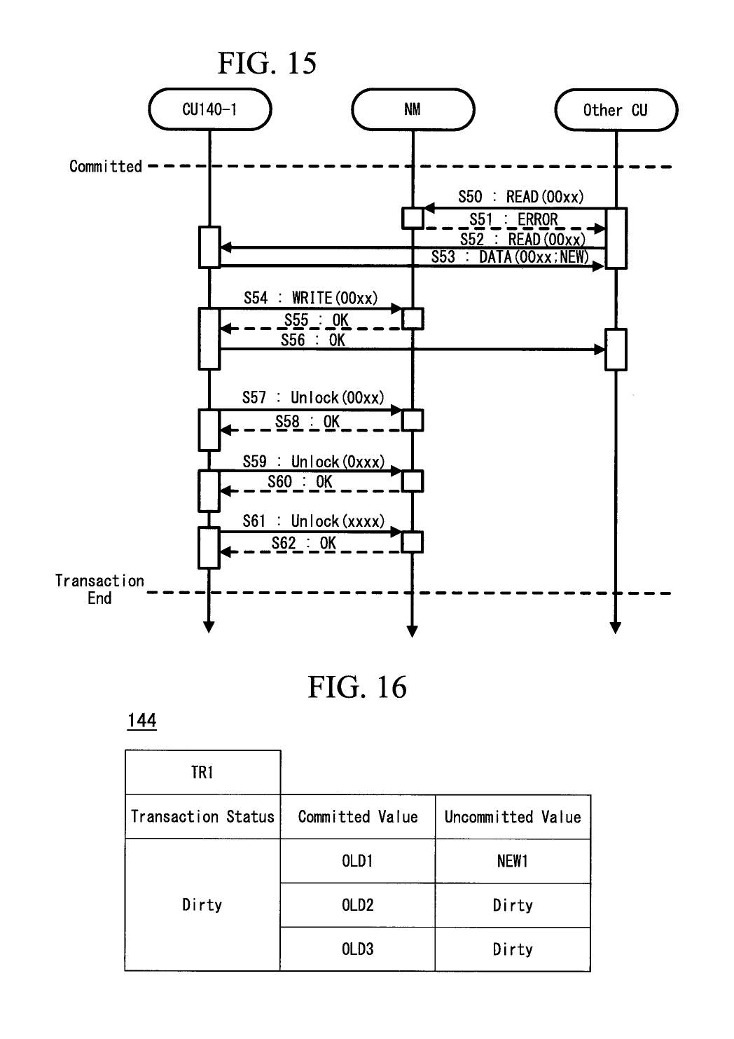

FIGS. 14 and 15 are sequence diagrams showing a flow of the process executed by the storage system 100 according to the second embodiment. Here, it is assumed that the transaction process is initiated by the connection unit 140-1 and that a target for writing data through the transaction process is one node module 150.

First, the connection unit 140-1 transmits a lock request designating an address (00xx) to the node module 150 (S30). In response thereto, the node module 150 returns information (OK in FIG. 14) indicating approval of the lock request unless any other connection unit 140 has already acquired approval of a lock request for the same address, and transmits data stored in the address (00xx) at that time to the connection unit 140-1 (S31). This communication causes the connection unit to become a priority connection unit for the address (00xx). The connection unit 140-1 stores the data received from the node module 150 in the CU memory 144.

Next, the connection unit 140-1 transmits a lock request designating an address (0xxx) to the node module 150 (S32). In response thereto, the node module 150 returns information (OK) indicating approval of the lock request unless any other connection unit 140 has already acquired approval of a lock request for the same address, and transmits data stored in the address (0xxx) at that time to the connection unit 140-1 (S33). This communication causes the connection unit 140-1 to become the priority connection unit for the address (0xxx). The connection unit 140-1 stores the data received from the node module 150 in the CU memory 144.

Next, the connection unit 140-1 transmits a lock request designating an address (xxxx) to the node module 150 (S34). In response thereto, the node module 150 returns information (OK) indicating approval of the lock request unless any other connection unit 140 has already acquired approval of a lock request for the same address, and transmits data stored in the address (xxxx) at that time to the connection unit 140-1 (S35). This communication causes the connection unit 140-1 to become the priority connection unit for the address (xxxx). The connection unit 140-1 stores the data received from the node module 150 in the CU memory 144.

Thereafter, when the node module 150 receives a write request designating the address (00xx) from a non-priority connection unit 140 (S36), the node module 150 returns information indicating an error together with identification information of the connection unit 140-1, which is a priority connection unit, to the non-priority connection unit 140 (S37). While the non-priority connection unit 140 may transmit a lock request to the node module 150 before the process in S36, FIG. 14 omits such a lock request by the non-priority connection unit 140.

The non-priority connection unit 140 transmits a write request designating the address (00xx) to the connection unit 140-1, which is the priority connection unit (S38). The connection unit 140-1 sets aside this write request (S39) and transmits data to the node module 150 as a proxy of the non-priority connection unit 140 after a write process based on the write request corresponding to the transaction process has been completed.

Next, the connection unit 140-1 transmits a write request designating the address (00xx) to the node module 150 (S40). The node module 150 writes data included in the write request into the designated address and returns, to the connection unit 140-1, information (OK) indicating that a write process based on the write request has been completed (S41).

Thereafter, when the node module 150 receives a read request designating the address (00xx) from a non-priority connection unit 140 (S42), the node module 150 returns information indicating an error together with identification information of the connection unit 140-1, which is the priority connection unit, to the different connection unit 140 (S43).

A non-priority connection unit 140 transmits a read request designating the address (00xx) to the connection unit 140-1, which is a priority connection unit (S44). Here, the connection unit 140-1 has not completed the “committing” of the transaction process, so that the connection unit 140-1 transmits, to the non-priority connection unit 140, data (OLD in FIG. 14) that were acquired from the node module 150 in S31 and stored in the CU memory 144 prior to the write process, not new data of which a write process has already been performed (S45).

Next, the connection unit 140-1 transmits a write request designating the address (0xxx) to the node module 150 (S46). The node module 150 writes data included in the write request to the address (0xxx) and returns, to the connection unit 140-1, information (OK) indicating that a write process based on the write request has been completed (S47). Next, the connection unit 140-1 transmits a write request designating the address (xxxx) to the node module 150 (S48). The node module 150 writes data included in the write request to the address (xxxx) and returns, to the connection unit 140-1, information (OK) which indicates that a write process based on the write request has been completed (S49).

Upon completion of the process in S49, the connection unit 140-1 completes transmitting the write requests on the transaction process. At this time, when the completion of the write processes for all write requests has been confirmed, the connection unit 140-1 performs the “committing” of the transaction process. Thereafter, when the connection unit 140-1 receives a read request for an address corresponding to the transaction process, the connection unit 140-1 returns new data for which a write process was performed.

Moving on to FIG. 15, when a non-priority connection unit 140 transmits a read request designating the address (00xx) to the node module 150 (S50), the node module 150 returns information indicating an error together with identification information of the connection unit 140-1, which is a priority connection unit, to the non-priority connection unit 140 (S51).

The non-priority connection unit 140 transmits a read request designating the address (00xx) to the connection unit 140-1 (S52). Here, the connection unit 140-1 has completed the “committing” of the transaction process, so that the connection unit 140-1 transmits new data for which a write process has already been performed (NEW in FIG. 15) to the non-priority connection unit 140 (S53). Data to be transmitted to the non-priority connection unit 140 may be data which are temporarily stored in the CU memory 144, or they may be data read from the node module 150 for transmitting to a non-priority connection unit.

Next, before releasing the locked state of the addresses, the connection unit 140-1 transmits a write request designating the address (00xx) that was set aside in S39 to the node module 150 as a proxy of the non-priority connection unit 140 (S54). The node module 150 returns information (OK) indicating that a write process based on the write request has been completed to the connection unit 140-1 (S55). The connection unit 140-1 returns, to the non-priority connection unit 140-1, information (OK) indicating that the write process based on the write request has been completed (S56). Transmission of the information indicating that the write process based on the write request has been completed from the connection unit 140-1 to the non-priority connection unit 140 may be performed before or after S39. This may increase an apparent response speed viewed from the client 400 of the non-priority connection unit 140.

Next, the connection unit 140-1 releases the locked state of the addresses. The connection unit 140-1 transmits, to the node module 150, an unlock request (Unlock in FIG. 15) to release the locked state of the address (00xx) (S57), and the node module 150 returns, to the connection unit 140-1, information (OK) indicating that the release was approved (S58). Next, the connection unit 140-1 transmits, to the node module 150, an unlock request (Unlock) for the address (0xxx) (S59), and the node module 150 returns, to the connection unit 140-1, information (OK) indicating that the release was approved (S60). Next, the connection unit 140-1 transmits, to the node module 150, an unlock request (Unlock shown) for the address (xxxx) (S61), and the node module 150 returns, to the connection unit 140-1, information (OK) indicating that the release was approved (S62). As a result, the locked state of the addresses is released, and the transaction process ends.

FIG. 16 illustrates an example of data stored in the CU memory 144 by the connection unit 140 which initiates a transaction process. “Transaction Status,” which shows whether the content of the transaction process has been finalized is stored in the CU memory 144 for respective identification information (TR1 in FIG. 16) of the transaction process. “Dirty” indicates that the content of the transaction process has not been finalized. Moreover, identification information (Committed Value in FIG. 16) of committed data at the corresponding address is stored in the CU memory 144 for each identification information of the transaction process. This example assumes that, as the transaction process which has the same identification information is repeatedly executed, the corresponding address is known even before requesting the transaction process. Moreover, identification information (Uncommitted Value) of uncommitted data, for which a write request need to be transmitted to the node module 150 is stored in the CU memory 144 for each identification information of the transaction process. The connection unit 140 refers to such internal statuses to execute processes in FIGS. 14 and 15.

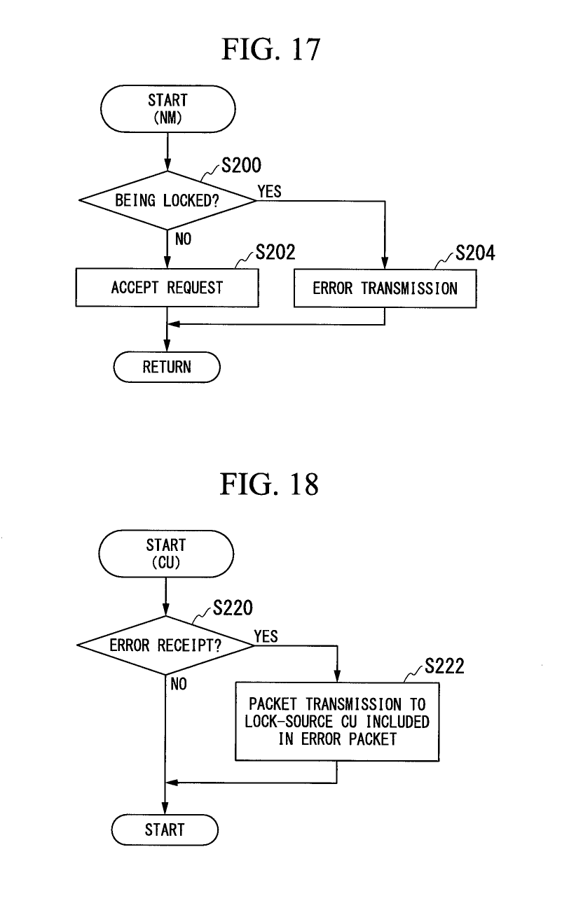

FIG. 17 is a flowchart illustrating a flow of a process executed by the node controller 151 of the node module 150 according to the second embodiment. The process of the present flowchart is executed each time an access request from a non-priority connection unit is received.

First, the node controller 151 refers to the information stored in the CU memory 144 as shown in FIG. 10 and determines whether an address designated by the access request is locked (S200). When the address is not locked (No in S200), the node controller 151 accepts the access request (S202). On the other hand, when the address designated by the access request is locked (Yes in S200), the node controller 151 returns, to the non-priority connection unit, information indicating an error together with identification information of the connection unit 140-1, which is a priority connection unit (S204).

FIG. 18 is a flowchart illustrating a flow of a process executed by the non-priority connection unit according to the second embodiment. The non-priority connection unit determines whether information (an error packet) which indicates an error is received from the node module 150 to which the access request was transmitted (S220). If the error packet is received, the non-priority connection unit transmits a packet including an access request to the priority connection unit (lock-source CU in FIG. 18) included in the error packet (S222).

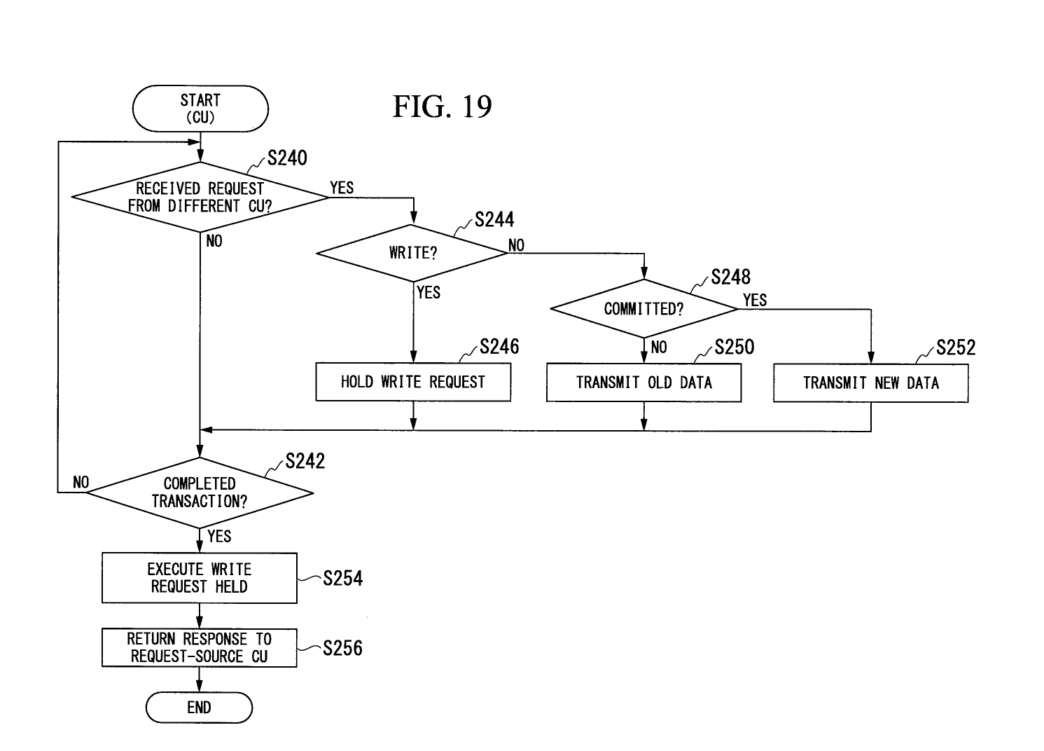

FIG. 19 is a flowchart illustrating a flow of a process executed by the priority connection unit according to the second embodiment. The process of the present flowchart is started when a transaction process is started.

First, the priority connection unit determines whether or not an access request from a non-priority connection unit is received (S240). When the access request from the non-priority connection unit is not received (No in S240), the priority connection unit determines whether or not a write process based on a write request corresponding to the transaction process has been completed (S242). When the write process based on the write request corresponding to the transaction process has not been completed (No in S242), the process returns to S240.

If it is determined that the access request from the non-priority connection unit is received (Yes in S240), the priority connection unit determines whether or not the received access request is a write request (S244). When the received access request is a write request (Yes in S244), the priority connection unit sets aside the received write request (S246), and the process proceeds to S242.

When the received access request is not a write request (No in S244), (i.e., a read request), the priority connection unit determines whether or not the transaction process has been committed (S248). When the transaction process has not been committed (No in S248), the priority connection unit transmits, to the non-priority connection unit, not new data for which a write process has already been performed, but data (OLD DATA) read prior to the write process and stored in the CU memory 144 (S250). When the transaction process has been committed, the priority connection unit transmits, to the non-priority connection unit, new data (NEW DATA in FIG. 19) for which a write process has already been performed (S252).

If it is determined that the write process based on the write request corresponding to the transaction process has been completed (Yes in S242), the priority connection unit, as a proxy of the non-priority connection unit, transmits, to the node module 150, the write request that was set aside in S246 (S254) and returns a response to the request-source non-priority connection unit (S256). Thereafter, an unlock request is transmitted to the node module 150 by the priority connection unit, completing the process.

The second embodiment as described above makes it possible to appropriately execute exclusive control in accordance with the system configuration.

According to the second embodiment, information indicating that a certain address is locked is transmitted to the non-priority connection unit 140 when there is an access request to the address. Alternatively, the information indicating the address lock may be transmitted to a plurality of non-priority connection units 140, including ones that have sent no access request, each time a certain address is locked. When a non-priority connection unit 140 transmits an access request to the same address, the non-priority connection unit 140 which received this information may transmit the access request to the priority connection unit, not to the node module 150.

### Third Embodiment

A third embodiment is described below. In the description below, the same numerals are used for elements of the storage system 100 that are same as those according to the first embodiment, and description thereof are omitted.

According to the third embodiment, if an access request with respect to an address is received from a non-priority connection unit, the node module 150 transmits an access request to a priority connection unit, and the priority connection unit which received the access request executes a process based on the access request. Here, the access request transmitted to the priority connection unit from the node module 150 includes identification information of the non-priority connection unit.

In this way, the connection unit 140 and the node module 150 may cooperate in the storage system 100 to appropriately execute exclusive control in accordance with the system configuration. Moreover, the number of communication times may be reduced compared to the second embodiment.

For example, according to the third embodiment, when the access request received from the node module is a write request, the priority connection unit, as a proxy of the non-priority connection unit, transmits the write request received from the node module to a node module corresponding to the address in the write request.

In this way, the storage system 100 may prevent data inconsistency caused by the node module accepting write requests on an unlimited basis. Moreover, since the non-priority connection unit does not need to repeatedly retransmit the write request, communication traffic within the storage system 100 can be reduced.

Moreover, according to the third embodiment, when the priority connection unit transmits, to the node module 150, a plurality of write requests accepted from the client 400 during a series of processes (transaction processes), the priority connection unit reads in advance data from target addresses of the plurality of write requests (read regardless of the presence/absence of a receipt of a read request). If a read request is received from the node module 150 after information indicating an approval of the lock request is received and before a write process based on the plurality of write requests is completed, the priority connection unit transmits the data read in advance to a non-priority connection unit that issued the read request.

This procedure of the storage system 100 can prevent data from being provided to the client 400 in a state in which only write processes based on some write requests of the transaction processes have been completed.

According to an alternative example of the third embodiment, when the priority connection unit transmits, to the node module 150, a plurality of write requests accepted from a client during a series of processes (transaction processes), the priority connection unit may not read data in advance from the target addresses of the write requests (in other words, from the node module 150) from the non-priority. Instead, the priority connection unit may read data from the target addresses of the write requests, when the priority connection unit receives a read request for the target addresses after information indicating an approval of the lock request is received and before a write process based on the plurality of the write requests have been completed, and transmit the read result to the non-priority connection unit.

Moreover, according to the third embodiment, when a read request is received from a node module 15 after the completion of the write process based on the plurality of write requests and before the locked state is released, the priority connection unit transmits data corresponding to the completed write request with a read request transmission-source non-priority connection unit as a destination.

According to this procedure, upon completion of the write process based on all write requests in a transaction process, the storage system 100 may provide new data rapidly to the client 400 without waiting for the process for lock release. Moreover, compared to the first embodiment, the read process may be accepted for a longer period of time, further increasing the responsiveness of the storage system.

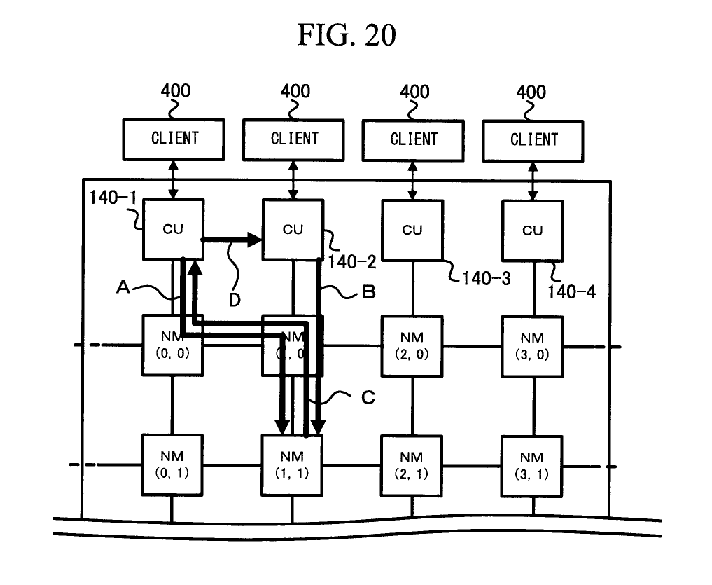

FIG. 20 illustrates an overview of the process executed in the storage system 100 according to the third embodiment. First, the connection unit 140-1 transmits, to the node module 150 (1, 1), a lock request (arrow A in FIG. 20), which is approved by the node module 150 (1, 1). Next, when the connection unit 140-2 sends an access request to the node module 150 (1, 1) (arrow B), the node module 150 (1, 1) transfers the received access request to the connection unit 140-1 (arrow C). The transferred access request includes identification information of the connection unit 140-2. The connection unit 140-1 performs a process based on the access request and transmits a response to the connection unit 140-2 (arrow D).

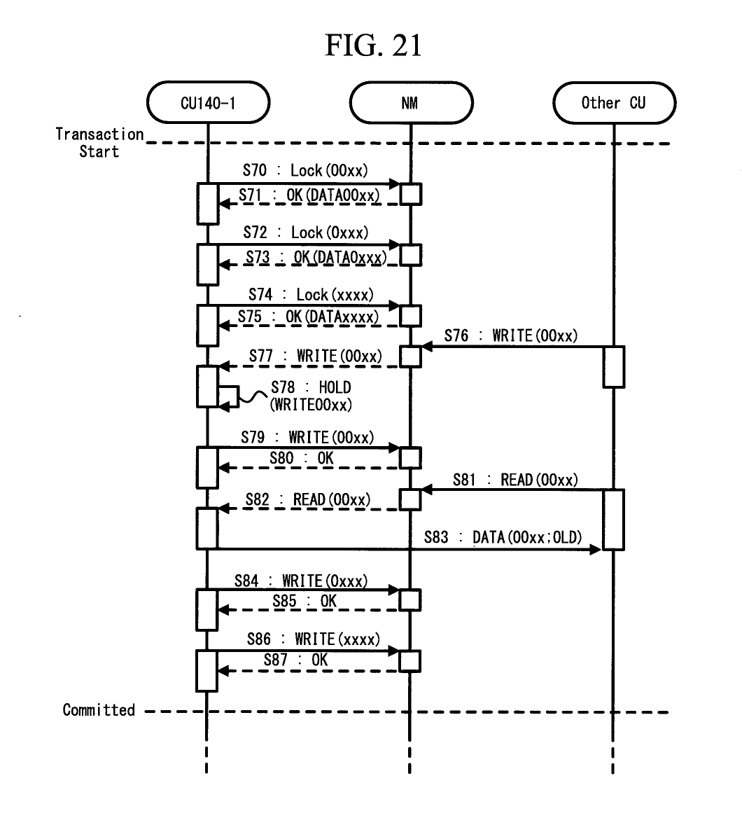

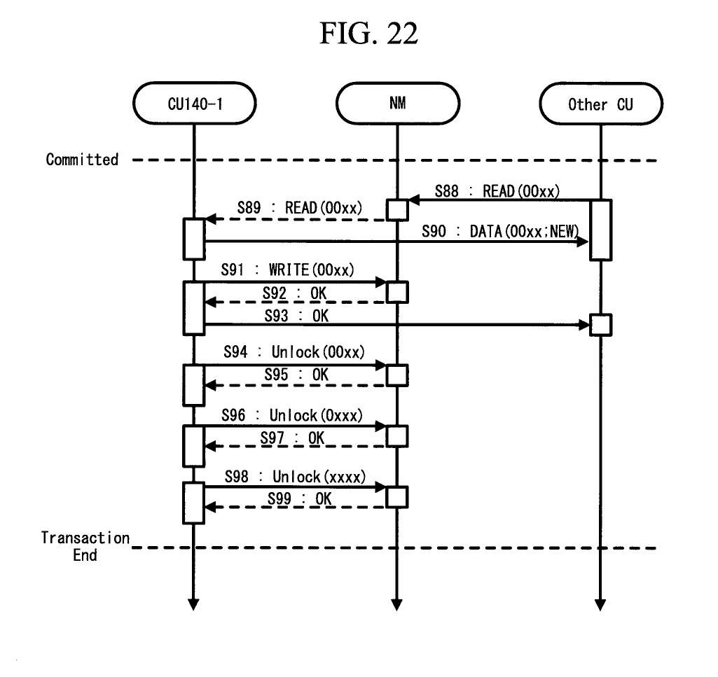

FIGS. 21 and 22 are sequence diagrams illustrating the flow of the process executed by the storage system 100 according to the third embodiment. Here, it is assumed that the transaction process is initiated by the connection unit 140-1. Moreover, it is assumed that a target for writing data through the transaction process is one node module 150.

First, the connection unit 140-1 transmits a lock request designating an address (00xx) to the node module 150 (S70). In response thereto, the node module 150 returns information (OK in FIG. 20) indicating approval of the lock request and data stored in the address (00xx) if no other connection units 140 had a lock request for the same address to be approved (S71). This procedure causes the connection unit 140-1 to become “a priority connection unit” for the address (00xx). The connection unit 140-1 stores the data received from the node module 150 in the CU memory 144.

Next, the connection unit 140-1 transmits a lock request designating an address (0xxx) to the node module 150 (S72). In response thereto, the node module 150 returns information (OK in FIG. 21) indicating approval of the lock request and data stored in the address (000x) if no other connection units 140 had a lock request for the same address to be approved (S71). This procedure causes the connection unit 140-1 to become “a priority connection unit” for the address (0xxx). The connection unit 140-1 stores the data received from the node module 150 in the CU memory 144.

Next, the connection unit 140-1 transmits a lock request designating an address (xxxx) to the node module 150 (S74). In response thereto, the node module 150 returns information (OK) indicating approval of the lock request and data stored in the address (xxxx) if no other connection units 140 had a lock request for the same address to be approved (S75). This procedure causes the connection unit 140-1 to become “a priority connection unit” for the address (xxxx). The connection unit 140-1 stores the data received from the node module 150 in the CU memory 144.

Thereafter, upon receiving a write request designating the address (00xx) from a non-priority connection unit 140 (S76), the node module 150 transfers the write request to the connection unit 140-1, which is the priority connection unit (S77). While the non-priority connection unit 140 may transmit a lock request to the node module 150 before S76, the description for this lock request is omitted in FIG. 21.

The connection unit 140-1, which is the priority connection unit, sets aside the write request received from the node module 150 (S78), and, after completion of a write process based on a write request corresponding to the transaction process, conducts a transmission to the node module 150 as a proxy of the non-priority connection unit 140.

Next, the connection unit 140-1 transmits a write request designating the address (00xx) to the node module 150 (S79). The node module 150 writes data included in the write request to the designated address and returns, to the connection unit 140-1, information (OK) indicating that a write process based on the write request has been completed (S80).

Thereafter, upon receiving a read request designating the address (00xx) from a non-priority connection unit 140 (S81), the node module 150 transfers the read request designating the address (00xx) to the connection unit 140-1, which is the priority connection unit (S82). Here, as the “committing” of the transaction process has not been completed, the connection unit 140-1, which is the priority connection unit, transmits, to the non-priority connection unit 140, instead of new data for which the write process has already been performed, but data (OLD) that were read from the node module 150 before the write process in S71 and stored in the CU memory 144 (S83).

Next, the connection unit 140-1 transmits a write request designating the address (0xxx) to the node module 150 (S84). The node module 150 writes data included in the write request into the designated address and returns, to the connection unit 140-1, information (OK) indicating that a write process based on the write request has been completed (S85). Next, the connection unit 140-1 transmits a write request designating the address (xxxx) to the node module 150 (S86). The node module 150 writes the data included in the write request into the designated address and returns, to the connection unit 140-1, information (OK) indicating that a write process based on the write request has been completed (S87).

Upon completion of S87, the connection unit 140-1 completes transmitting the write requests for the transaction process and confirms completion of the write process for all write requests, so that the connection unit 140-1 conducts the “committing” of the transaction process. Thereafter, if a read request for an address corresponding to the transaction process is received, the connection unit 140-1 returns new data that have been written through the write process.

Moving to FIG. 22, upon receiving a read request designating the address (00xx) from a non-priority connection unit 140 (S88), the node module 150 transfers a read request designating the address (00xx) to the connection unit 140-1, which is a priority connection unit (S89). Here, since the connection unit 140-1, which is the priority connection unit, has completed the “committing” of the transaction process, new data that have been written through the write process (NEW) are transmitted to the non-priority connection unit 140 (S90). The data transmitted to the different connection unit 140 may be data temporarily stored in the CU memory 144, or data read from the node module 150 for transmitting to the non-priority connection unit.

Next, the connection unit 140-1 transmits, to the node module 150 as a proxy of the non-priority connection unit 140, the write request designating the address (00xx) that was set aside in S78 before releasing a locked state of the locked addresses (S91). The node module 150 returns, to the connection unit 140-1, information (OK) indicating that a write process based on the write request has been completed (S92). The connection unit 140-1 transmits, to the non-priority connection unit 140-1, information (OK) indicating that the write process based on the write request has been completed (S93). Transmission of the information indicating that the write process based on the write request has been completed from the connection unit 140-1 to the non-priority connection unit 140 may be performed before or after S78. This procedure may increase the apparent response speed as viewed from the client 400 of the different connection unit.

Next, the connection unit 140-1 releases the locked state of the locked addresses. The connection unit 140-1 transmits, to the node module 150, an unlock request (Unlock) to release the locked state of the address (00xx) (S94) and the node module 150 returns, to the connection unit 140-1, information (OK) indicating that the release was approved (S95). Next, the connection unit 140-1 transmits, to the node module 150, an unlock request (Unlock) for the address (0xxx) (S96) and the node module 150 returns, to the connection unit 140-1, information (OK) indicating that the release was approved (S97). Next, the connection unit 140-1 transmits, to the node module 150, an unlock request for the address (xxxx) (Unlock) (S98) and the node module 150 returns, to the connection unit 140-1, information (OK) indicating that the release was approved (S99). This procedure causes the locked state of the locked addresses to be released, and the transaction process ends.

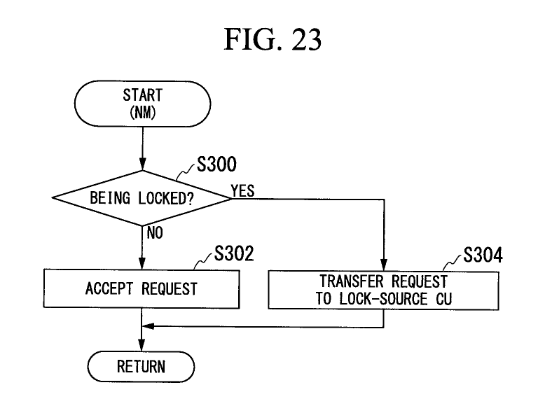

FIG. 23 is a flowchart illustrating the flow of the process executed by the node controller 151 of the node module 150 according to the third embodiment. The process of the present flowchart is executed each time an access request is received from a non-priority connection unit.

First, the node controller 151, referring to the information exemplified in FIG. 10, determines whether or not an address designated by the access request is being locked (S300). When the address is not locked (No in S300), the node controller 151 accepts the access request (S302). On the other hand, when the address designated by the access request is locked (Yes in S300), the node controller 151 transfers the access request to the connection unit 140-1, which is the priority connection unit (lock-source connection unit) (S304). The node module 150 transmits identification information of the non-priority connection unit that issued the access request together with the access request.

The above-described third embodiment enables an appropriate exclusive control in accordance with the system configuration.

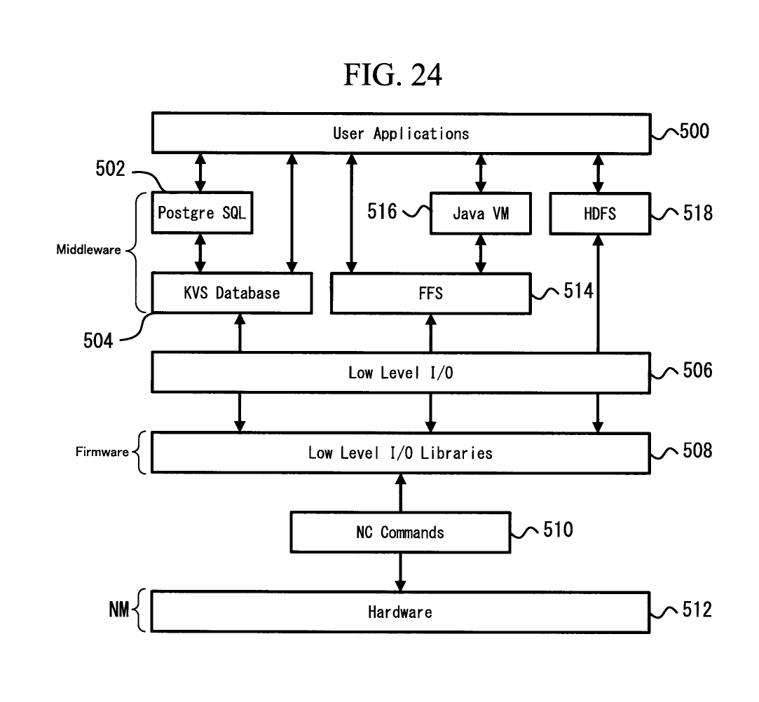

FIG. 24 illustrates an example of hardware and software structure of the storage system 100 that can be applied to the above-described embodiments. Of the elements shown in FIG. 24, user applications 500 are included in the client 400. A Postgre SQL 502, a KVS database 504, a low-level I/O 506, low-level I/O libraries 508, NC commands 510, hardware 512, an FFS 514, a Java VM 516, and an HPFS (Hadoop distributed file system) 518 may be included in the storage system 100. The configuration of the storage system 100 is not limited thereto.

Moreover, of the elements shown in FIG. 24, the Postgre SQL 502, the KVS database 504, the FFS 514, the Java VM 516, and the HPFS 518 represent middleware which operates in the connection unit 140. Moreover, the low-level I/O libraries 508 represents firmware which operates in the connection unit 140. Furthermore, of the elements shown in FIG. 24, the node controller 151 and the first NM memory 152 are included in the hardware 512.

The user applications 500 operate in the client 400 and generate various commands for the storage system 100 based on operations by the user.

The Postgre SQL 502 functions as an SQL database. The SQL is a database language for performing operations and definitions of data in a relational database management system. The Postgre SQL 502 converts SQL input commands to KVS input commands. The KVS Database 504 functions as a non-SQL database server. The KVS database 504 has a hash preparation function and mutually converts between arbitrary key information and a logical address (LBA) or between arbitrary key information and a physical address.

The low-level I/O 506 functions as an interface between the middleware and the firmware. The low-level I/O libraries 508 has a virtual drive control function, a hash configuration function, etc., and functions as an interface between the connection unit 140 and the node controller 151.

The NC commands 510 is a command interpreted by the node controller 151.

The hardware 512, as described previously, has a packet routing function, a function of intermediating communications between connection units, a RAID configuration function, a function of performing read and write processes, a lock execution function, a simple calculation function, etc. Moreover, the hardware 512 has a wear leveling function within the node module, a function of writing back from a cache, etc. The wear leveling function is a function of controlling such that the numbers of times of rewrites become uniform among memory elements.

The FFS 514 provides a distributed file system. The FFS 514 is implemented in each of the connection units 140 such that data consistency is ensured when the same node module 150 is accessed from the plurality of connection units 140. The FFS 514 receives commands from the user applications 500, etc., distributes the received commands, and transmits the distributed results.

The Java VM 516 is a stack-type Java virtual machine which executes an instruction set defined as the Java byte code. The HDFS 518 divides a large file into a plurality of block units and stores the divided result in the plurality of node modules 150 in a distributed manner.

A storage system according to at least one embodiment may include a non-volatile memory 151; a plurality of node modules which transmit data to a destination node module via a communications network which connects the node modules 150; and a plurality of connection units 140 which, if a write command instructing to write data into the non-volatile memory is received from a client 400, transmits a write request to write the data into the non-volatile memory, wherein the connection unit transmits a lock request to lock an address in which data are to be written to a node module, which is a destination of the write request, and the node module determines a first connection unit from the plurality of connection units, and executes a write process to write data at the address based on the write request received from the first connection unit.

While certain embodiments have been described, these embodiments have been presented by way of example only, and are not intended to limit the scope of the inventions. Indeed, the novel embodiments described herein may be embodied in a variety of other forms; furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage system, comprising:
a storage unit having a plurality of routing circuits networked with each other, each of the routing circuits configured to route packets to a plurality of node modules that are connected thereto, each of the node modules including nonvolatile memory; and
a plurality of connection units, each coupled with one or more of the routing circuits for communication therewith, and configured to access each of the node modules through one or more of the routing circuits, wherein
when a first connection unit transmits to a target node module a lock command to lock a memory region of the target node module for access thereto, and then a second connection unit transmits a write command to the target node module before the first connection unit transmits to the target node module an unlock command to unlock the memory region, the target node module is configured to return an error notice to the second connection unit.

2. The storage system according to claim 1, wherein
the write command is for writing data into the memory region of the target node module.

3. The storage system according to claim 1, wherein
the write command is for writing data into another memory region of the target node module.

4. The storage system according to claim 1, wherein
when the first connection unit transmits the lock command to the target node module, and then the second connection unit transmits to the target node module a read command to read data from the memory region before the first connection unit transmits to the target node module a write command to write data into the memory region, the target node module is configured to return data read from the target node module to the second connection unit.

5. The storage system according to claim 1, wherein
when the first connection unit transmits the lock command to the target node module, and then the second connection unit transmits to the target node module a read command to read data from the memory region after the first connection unit transmits to the target node module a write command to write data into the memory region, the target node module is configured to return an error notice to the second connection unit.

6. The storage system according to claim 1, wherein
when the second connection unit transmits to the target node module an access command after each memory region of the target node module becomes unlocked, the target node module is configured to allow access to a memory region thereof in accordance with the access command.

7. The storage system according to claim 1, wherein
when the first connection unit accesses a plurality of memory regions of the target node modules during a single access operation with respect to the target node module, the first connection unit sequentially transmits, to the target node module, a plurality of lock commands, each corresponding to one of the memory regions, and then a plurality of write commands, each corresponding to one of the memory regions.

8. The storage system according to claim 7, wherein
after transmitting the plurality of write command, the first connection unit further sequentially transmits, to the target node module, a plurality of unlock commands.

9. A storage system, comprising:
a storage unit having a plurality of routing circuits networked with each other, each of the routing circuits configured to route packets to a plurality of node modules that are connected thereto, each of the node modules including nonvolatile memory; and
a plurality of connection units, each coupled with one or more of the routing circuits for communication therewith, and configured to access each of the node modules through one or more of the routing circuits, wherein
when a first connection unit transmits to a target node module a lock command to lock a memory region of the target node module for access thereto, and then a second connection unit transmits to the first connection unit a write request to write data into the memory region before the first connection unit transmits to the target node module an unlock command to unlock the memory region, the first connection unit is configured to access the target node module in accordance with the write request, in place of the second connection unit.

10. The storage system according to claim 9, wherein
the first connection unit accesses the target node module in accordance with the write request before the first connection unit transmits the unlock command to the target node module.

11. The storage system according to claim 9, wherein
when the first connection unit transmits the lock command to the target node module, and then the second connection unit transmits to the first connection unit a read request to read data from the memory region before the first connection unit transmits the unlock command to the target node module, the first connection unit is configured to return data read from the memory region to the second connection unit.

12. The storage system according to claim 11, wherein
the data read from the memory region are data that have been stored therein before the first connection unit writes data therein, when data writing into each memory region of the target node module through an access from the first connection unit has not completed.

13. The storage system according to claim 11, wherein
the data read from the memory region are data that have been written through an access from the first connection unit, when data writing into each memory region of the target node module through the access from the first connection unit has completed.

14. A storage system, comprising:
a storage unit having a plurality of routing circuits networked with each other, each of the routing circuits configured to route packets to a plurality of node modules that are connected thereto, each of the node modules including nonvolatile memory; and
a plurality of connection units, each coupled with one or more of the routing circuits for communication therewith, and configured to access each of the node modules through one or more of the routing circuits, wherein
when a first connection unit transmits to a target node module a lock command to lock a memory region of the target node module for access thereto, and then a second connection unit transmits to the target node module an access command before the first connection unit transmits to the target node module an unlock command to unlock the memory region, the target node module is configured to transfer the access command to the first connection unit.

15. The storage system according to claim 14, wherein
the first connection unit is further configured to access the target node module in accordance with the access command.

16. The storage system according to claim 15, wherein
the first connection unit accesses the target node module in accordance with the access command before the first connection unit transmits the unlock command to the target node module.

17. The storage system according to claim 16, wherein
when the access command is a write command to write data into the memory region, the first connection unit accesses the target node module in accordance with the write command after data writing initiated by the first connection unit has completed.

18. The storage system according to claim 16, wherein
when the access command is a read command to read data from the memory region, the first connection unit is configured to transmit data read from the memory region to the second connection unit.

19. The storage system according to claim 18, wherein
the data read from the memory region are data that have been stored therein before the first connection unit writes data therein, when data writing initiated by the first connection unit has not completed.

20. The storage system according to claim 18, wherein
the data read from the memory region are data that have been written through data writing initiated by the first connection unit, when data writing initiated by the first connection unit has completed.
